(19) United States
(12) Patent Application Publication
(10) Pub. No.: US 2022/0095544 A1
(43) Pub. Date: Mar. 31, 2022

(54) QR Code Plant Monitoring

(71) Applicant: Phylos Bioscience, Inc., Portland, OR (US)

(72) Inventors: Courtland Fowler, Portland, OR (US); Rebecca Kirkpatrick, Portland, OR (US); Kenichi Nakamura, Portland, OR (US)

(21) Appl. No.: 17/483,620

(22) Filed: Sep. 23, 2021

Related U.S. Application Data
(60) Provisional application No. 63/085,716, filed on Sep. 30, 2020.

(51) Int. Cl. A01G 7/00; A01G 22/00; G06K 7/14; H04W 4/02; H04W 4/80

(52) U.S. Cl. CPC A01G 7/00; A01G 22/00; H04W 4/80; H04W 4/025; G06K 7/1417

(57) ABSTRACT

Provided herein are methods and systems for monitoring plants. A QR code can be associated with a plant, wherein a static QR code can be associated with a plant. The static QR code can be dynamically scanned and encoded with data that identifies the plant and contains information about the plant. The information may include geolocation information and/or image files that monitor the developmental stages of the plant. The encoded data may then be transmitted over a network to retrievable storage.

### BACKGROUND OF THE INVENTION

This application is directed to the fields of tracking plant growth characteristics. Modern plant breeding utilizes data relating to factors that affect growth characteristics during plant development. Gathering information relating to a plant's health during plant development is useful for maximizing breeding efficacy.

Such information may include, for example, photographs taken of individual plants at multiple stages of development. However, manually categorizing and naming innumerable image files reduces the practicality of acquiring large numbers of image files because of the time-consuming and error prone nature of such manual processing. The present invention solves this problem through the use of a quick reference (QR) code that associates an individual plant with identifying information, such as images of the plant, that can easily transmit the information to retrievable storage in an efficient and error-free manner.

### SUMMARY OF THE INVENTION

The present teachings relate to monitoring plant growth characteristics. In one embodiment, a method for monitoring plants is provided. In this embodiment method comprises associating a quick reference (QR) code with a plant, scanning the QR code, obtaining information regarding the plant, and encoding the QR code with data, wherein the encoded data comprises the information regarding the plant. In an embodiment, the method further comprises transmitting the data to retrievable storage. In an embodiment the transmitting occurs through a cellular, wireless, or bluetooth network. In an embodiment the method further comprises statically displaying the QR code on a stake that is associated with the plant. In an embodiment, the method further comprises dynamically displaying the QR code in a dynamic display area of a mobile device prior to the scanning and encoding. In an embodiment the information regarding the plant comprises geolocation information, manually inputted plant characteristic information, and/or one or more image files. In an embodiment the method further comprises acquiring the one or more image files using the mobile device. In an embodiment each of the image files comprise a prefix identifier that distinguishes the image files. In an embodiment the image files illustrate a developmental stage and/or location of the plant. In an embodiment the plant is a Cannabis plant.

In another embodiment a system for monitoring a plant is provided. In this embodiment the system comprises a plant, a quick reference (QR) code associated with the plant, information about the plant, and a QR code processing unit configured to analyze the QR code; and wherein said QR code is scanned and the data is encoded with the information comprising representative of the plant. In an embodiment the data is transmitted to retrievable storage. In an embodiment the data is transmitted through a cellular, wireless, or bluetooth network. In an embodiment the QR code is statically displayed on a stake that is associated with the plant. In an embodiment the QR code is dynamically displayed in a dynamic display area of a mobile device prior to the scanning and encoding. In an embodiment the information regarding the plant comprises geolocation information, manually inputted plant characteristic information, and/or one or more image files. In an embodiment the one or more image files are acquired using the mobile device. In an embodiment each of the image files comprise a prefix identifier that distinguishes the image files. In an embodiment the image files illustrate a developmental stage and/or location of the plant. In an embodiment the plant is a Cannabis plant.

### BRIEF DESCRIPTION OF THE DRAWINGS

The skilled artisan will understand that the drawings, described below, are for illustration purposes only. The drawings are not intended to limit the scope of the present teachings in any way.

FIG. 1 illustrates the process of encoding a QR code with plant information associated with an individual plant that can be transmitted to long term retrievable storage.

FIG. 2 illustrates a schematic diagram of a QR code system for use in monitoring plant development.

### DETAILED DESCRIPTION OF THE INVENTION

The present teachings relate generally to monitoring plant development. The embodiments described herein offer a solution that enables individuals such as plant breeders to transmit easily QR code encoded data comprising plant information to retrievable storage in an efficient and error-free manner. These and other features of the present teachings will become more apparent from the description herein. While the present teachings are described in conjunction with various embodiments, it is not intended that the present teachings be limited to such embodiments. On the contrary, the present teachings encompass various alternatives, modifications, and equivalents, as will be appreciated by those of skill in the art.

The terminology used in the disclosure herein is for the purpose of describing particular embodiments only and is not intended to be limiting of the disclosure. As used in the description of the embodiments of the disclosure and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs.

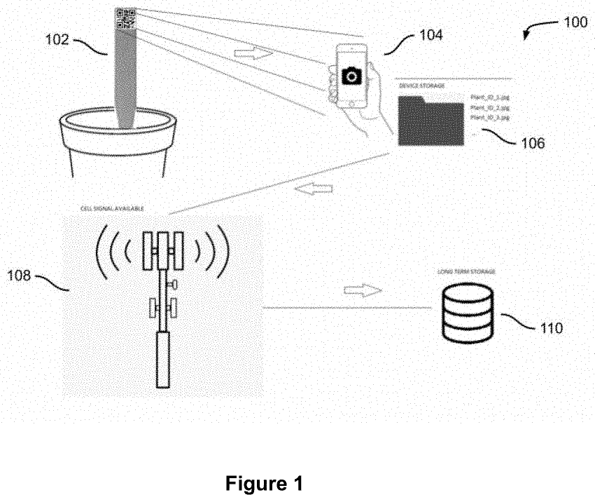

FIG. 1 illustrates the process of encoding a QR code with plant information associated with an individual plant that can be transmitted to long term retrievable storage (100). Different types of QR code systems can be implemented in accordance with varying embodiments. As shown in FIG. 1, a static QR code can be associated with an individual plant (102). The static QR code can be fixated on any medium that associates the QR code with the plant. A non-limiting example, as shown in FIG. 1, is a plant stake positioned within a planting pot. The static QR code may also be embedded with geolocation data for tracking purposes to allow a user to know the precise location of the plant.

In an embodiment, the plant is a Cannabis plant. However, a skilled artisan will appreciate that the present invention can be utilized and practiced for any plant.

As shown in FIG. 1, a dynamic QR code can be associated with a mobile device (104) in a dynamic display arrangement. A mobile device, for example a consumer grade mobile smartphone, tablet computing device, a wearable computing device, etc., can provide a medium to render and graphically display a dynamic display (e.g., an LCD (Liquid Crystal Display)). The dynamic display can be utilized to render a QR code such as the static QR code positioned on a stake (102).

The term “QR” as utilized herein can refer to a QR code and/or data associated with such a QR code. A QR or QR code is a multi-dimensional code that may be utilized in the context of various forms of communications. For example, a QR code can be used in advertisements to encode a company's web link. A QR code may be a specific multi-dimensional machine readable code that is designed to be read by portable optical type reading mechanisms such as smartphones. The information encoded may be text, a URL, or other data such as image files.

In an embodiment of the present invention the QR code is encoded with data that includes information identifies the plant. In an embodiment the QR code is also encoded with data containing information regarding the plant. The data containing information regarding the plant may include information relating to the location of the plant. In an embodiment the information are image files, which may be representative photographs that represent a plant's health, development stage, or other biological characteristics. In an embodiment, the information is manually inputted plant characteristics.

Other types of multi-dimensional machine readable codes may be utilized in the present embodiments in lieu of or in association with, for example, the disclosed QR codes. For example, a multi-dimensional code may be a 2D (two-dimensional) barcode that is a graphical image that stores information both horizontally, as one-dimensional bar codes do, and vertically. One feature may be how the 2D code can be used to encode virtually all required design and functional characteristics of a field device/panel, a mobile device, etc. The data may be read and consumed directly into the application offline. It does not necessarily require any other machine or server to fetch the data.

The scenarios incorporated herein do not necessarily contain multidimensional codes that represent actual end results. For example, a QR code for encrypted information and a QR code for a compressed schematic are not necessarily available. They may be explained in text form to describe the idea, but in reality they can be implemented in binary encoded QR form. There may be various new scenarios for use of a QR code other than multi-dimensional codes. Other versions of visual machine readable codes may be read. As an example of a code, the QR code may be used herein for illustrative purposes in the description of the present embodiments.

The mobile device can function to gather information about the plant, and can be either an industrial or consumer grade mobile device. For example, the mobile device may include a camera (104) that takes photographs of the plant and creates information in the form of an image file. In an embodiment the information comprises an image file associated with the photographs. The present invention can include information about the plant other than image files. For example, information about the plant can include manually inputted descriptions of the plant, e.g., plant height, color, overall appearance, nutrients used, or other environmental factors that might affect a plant's development. Manually inputted characteristics can be inputted via apps associated with a mobile device.

In an embodiment the mobile device may locally store the image files (106). This allows a user to store many thousands of images on a mobile device and subsequently transfer the images to long term storage at a later time in one or more batches. This embodiment of the invention is particularly use when the user is collecting information without network connectivity.

In an embodiment the mobile device can further include a function, for example via an app, that encodes the QR code with the image file or other information. In an embodiment the information may include images files that comprise a prefix identifier that distinguishes the image files. Associating prefix identifiers with image files is well known in the art, and can be accomplished by many means, e.g., through the use of a mobile device app. In a further embodiment, users may configure an optional prefix that will also be applied to each image, for use in distinguishing images of the same plant, where otherwise the resulting image might have the same identifier as an image that already exists in device storage, thus preventing new images with that name from being stored properly.

As shown in FIG. 1, an embodiment includes the transmission (108) of the QR code encoded data from the mobile device to long term retrievable storage. The QR code encoded data can be transmitted via any one of many different forms of transmission known in the art, including but not limited to transmission through a cellular, wireless, or bluetooth network.

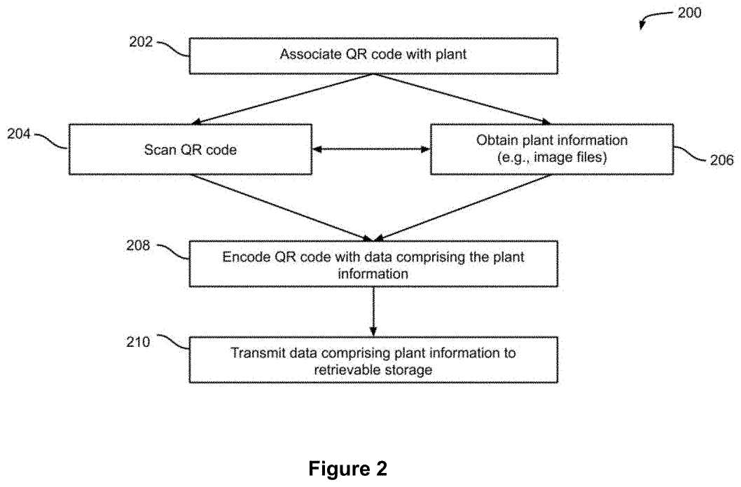

FIG. 2 illustrates a schematic diagram of a system for monitoring plants (200), which includes the same features depicted in FIG. 1. For example, the association of the QR code with the plant (202) can be the stake (102) illustrated in FIG. 1; scanning the QR code (204) can be accomplished with the smartphone (104) illustrated in FIG. 1; transmitting data to retrievable storage (210) can be via a cellular network (108) as illustrated in FIG. 1, etc.

In some embodiments, a step or operation can be implemented for storing the data in response to the scanning and the encoding of the QR code. In some embodiments, the storing occurs locally on the mobile device (104) and (106). In some embodiments, the storing occurs at an offsite retrievable data drive (110) wherein the information is stored via transmission (108) and (210) from the mobile device (104) to the retrievable storage (110).

In another embodiment, a step or operation can be provided for displaying the data in a display area of a mobile device (104) in response to the scanning (204) and the encoding (208) of the static QR code (102) and is associated with the plant (202). In another embodiment, a step or operation can be provided for displaying the data comprising information about the plant, e.g., images, in a display area of a mobile device (104) in response to the scanning (204) and the encoding (208) of the static QR code (102). Thus, a step or operation can be implemented for dynamically displaying the QR code within a dynamic display that is associated with the field device; the QR code can be dynamically generated and displayed via the dynamic display in response to a user input; and a step or operation can be provided for statically displaying the QR code on and in association with the field device.

As illustrated in FIG. 2, an embodiment of the present invention comprises acquiring data from scanning a static QR code associated with the plant (204) and another embodiment comprises acquiring data from obtaining plant information, e.g., images of various stages of plant growth or manually inputted plant characteristics (206). The steps associated with (204) and (206) include the further steps of encoding the QR code (208) with data from (204) and (206). A skilled artisan will appreciate that, as illustrated in FIG. 2, either one of steps (204) and (208) can occur in any sequential order. The present invention should not be limited by the steps in which image files containing information about the plant is captured or by whether scanning of the static QR code is captured.

As can be appreciated by one skilled in the art, some example embodiments can be implemented in the context of a method, data processing system, or computer program product. Accordingly, some example embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, consumer grade mobile device storage, databases, etc. Additionally, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, etc.

Computer program code for carrying out operations of the present invention may be written in an object-oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's mobile device or computer, partly on the user's mobile device or computer, as a stand-alone software package, partly on the user's device and partly on a remote computer or mobile device, or entirely on the remote computer or mobile device. In the latter scenario, the remote computer or mobile device may be connected to a user's computer through a local area network (LAN) or a wide area network (WAN), wireless data network (e.g., Wi-Fi, Wimax, 802.xx, a cellular network, an industrial wireless network, etc.), or the connection may be made to an external computer via most third party supported networks (for example, through the Internet utilizing an Internet Service Provider, mobile hotspot, or cellular network).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer or mobile device, special-purpose computer or mobile device, or other programmable data processing apparatus to produce a machine, such that the instructions, which execute via the processor of the computer or other programmable data processing apparatus such as a mobile device, create means for implementing the functions/acts specified in the block or blocks.

These computer program instructions may also be stored in a computer-readable memory that can direct a computer or other programmable data processing apparatus such as a mobile device to function in a particular manner, such that the instructions stored in the computer-readable memory produce an article of manufacture including instruction means which implement the function/act specified in the various block or blocks, flowcharts, and other architecture illustrated and described herein.

Note that a processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general-purpose processor, a digital signal processor (DSP), an integrated circuit, a server, other programmable logic device, or any combination thereof. A processor may be a conventional processor, microprocessor, controller, microcontroller, or state machine. A processor can also refer to a chip or part of a chip (e.g., semiconductor chip). The term “processor” may refer to one, two, or more processors of the same or different types. It is noted that a computer, computing device and user device, and the like, may refer to devices that include a processor, or may be equivalent to the processor itself.

The computer program instructions may also be loaded onto a computer or other programmable data processing apparatus such as a mobile device to cause a series of operational steps to be performed on the computer or mobile device to produce a computer implemented process such that the instructions that execute on the computer or mobile device provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved, as illustrated in FIG. 2 (e.g., (204) and (206). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure and all such modifications are intended to be included within the scope of the disclosure.

What is claimed is:

1. A method for monitoring plants, the method comprising: associating a quick reference (QR) code with a plant, scanning the QR code, obtaining information regarding the plant, and encoding the QR code with data, wherein the encoded data comprises the information regarding the plant.

2. The method of claim 1 further comprising transmitting the data to retrievable storage.

3. The method of claim 2 wherein the transmitting occurs through a cellular, wireless, or bluetooth network.

4. The method of claim 1 further comprising statically displaying the QR code on a stake that is associated with the plant.

5. The method of claim 1 further comprising dynamically displaying the QR code in a dynamic display area of a mobile device prior to the scanning and encoding.

6. The method of claim 1 wherein the information regarding the plant comprises geolocation information, manually inputted plant characteristic information, and/or one or more image files.

7. The method of claim 6 comprising acquiring the one or more image files using the mobile device.

8. The method of claim 6 wherein each of the image files comprise a prefix identifier that distinguishes the image files.

9. The method of claim 6 wherein the image files illustrate a developmental stage and/or location of the plant.

10. The method of claim 1 wherein the plant is a Cannabis plant.

11. A system for monitoring a plant, the system comprising: a plant, a quick reference (QR) code associated with the plant, information about the plant, and a QR code processing unit configured to analyze the QR code; and wherein said QR code is scanned and the data is encoded with the information comprising representative of the plant.

12. The system of claim 11 wherein the data is transmitted to retrievable storage.

13. The system of claim 11 wherein the data is transmitted through a cellular, wireless, or bluetooth network.

14. The system of claim 11 wherein the QR code is statically displayed on a stake that is associated with the plant.

15. The system of claim 11 wherein the QR code is dynamically displayed in a dynamic display area of a mobile device prior to the scanning and encoding.

16. The system of claim 11 wherein the information regarding the plant comprises geolocation information, manually inputted plant characteristic information, and/or one or more image files.

17. The system of claim 16 wherein the one or more image files are acquired using the mobile device.

18. The system of claim 16 wherein each of the image files comprise a prefix identifier that distinguishes the image files.

19. The system of claim 16 wherein the image files illustrate a developmental stage and/or location of the plant.

20. The system of claim 1 wherein the plant is a Cannabis plant.
